(19) United States
(12) Patent Application Publication
(10) Pub. No.: US 2018/0287271 A1
(43) Pub. Date: Oct. 4, 2018

(54) ELECTRICALLY INSULATING CAP COMPRISING A TUBE FOR RECEIVING ONE OR MORE ELECTRICAL WIRES

(71) Applicant: LAMINA DIELECTRICS LTD., Billingshurst (GB)

(72) Inventors: Patrick Hester, Billingshurst (GB); David Gough, Littlehampton (GB)

(21) Appl. No.: 16/061,120

(22) PCT Filed: Dec. 9, 2016
(86) PCT No.: PCT/GB2016/053889

§ 371 Date: Jun. 11, 2018

(30) Foreign Application Priority Data
Dec. 11, 2015 (GB) 1521905.8

(51) Int. Cl. H01R 4/22; H01R 4/72; H02G 3/04

(52) U.S. Cl. CPC H01R 4/22; H02K 3/32; H02G 3/0462; H01R 4/72

(57) ABSTRACT

There is provided an electrically insulating cap including a tube having a tube radius, an opening at a first end of the tube for receiving electrical wires, and a joint between two opposing sides of the tube within an interior of the tube. The joint blocks the tube at a point along a length of the tube to prevent the electrical wires from entering beyond a fixed distance into the tube. The joint is spaced away from a second end of the tube by a standoff distance, the second end of the tube being opposite the first end of the tube. The standoff distance is greater than the radius of the tube and less than five times the radius of the tube. The tube is formed of an outer tube of a non heat shrinkable material around an inner tube of a heat shrinkable material.

### RELATED APPLICATIONS/FIELD OF THE INVENTION

This Application is U.S. National Phase Application, claiming priority to Patent Cooperation Treaty (PCT) Application No. PCT/GB/2016/053889, filed on 9 Dec. 2016, which in turn claims priority to Great Britain Patent Application No. GB 1521905.8, filed on 11 Dec. 2015, each entitled “Electrically Insulating Cap Comprising A Tube for Receiving One or More Electrical Wires,” and each incorporated by reference here in its entirety. This invention relates to an electrically insulating cap, comprising a tube for receiving electrical wires. The electrically insulating caps are for use particularly, but not exclusively, in electrical motors.

### BACKGROUND OF THE INVENTION

It is known to provide electrically insulating caps for insulating electrical components, such as crimped connections to magnet wires within electric motors, or thermal switches used within motor windings.

Such caps are made from tubes, which may be wound from a combination of different polymeric films provided in strips. With this construction the caps have electrical and mechanical properties which are difficult to produce by other means. For example, by forming the tubes from different films the resulting caps can have a modified polyamide interior layer and a heat shrinkable polyester outer layer. Alternatively, the tubes may be purely formed of heat shrinkable material. Various electrically insulating cap formations are described in the Applicant's earlier U.S. Pat. No. 8,592,684 and U.S. Pat. No. 8,686,294.

The formed tubes are cut into small pieces and closed by flattening an end of the tube and welding it together, or heat forming it into that shape. The schematic diagrams of FIGS. 1a, 1b, and 1c show plan, cross-sectional, and end views of an electrically insulating cap which has been formed in this manner. The cross section of FIG. 1b is taken along line 5 marked on FIG. 1a, and the end view of FIG. 1c is taken from a direction 6 marked on FIG. 1b. The electrically insulating cap comprises a tube 1 which is closed by a flattened end 2. The flattened end 2 is formed by sonically welding opposing sides 2a and 2b of the tube to one another.

In use, electrical wires can be inserted into the open end of the tube 1, up to the closed end 2, and shrunk around the electrical wires with heat to grip the insulation around the wires and hold the cap in place.

During manufacture of an electrical motor, the cap may be used as a sheath over a connection between two electrical wires of the motor windings. The cap is fitted over the connection, then heat-shrunk, and may then be inserted into the motor windings. The flattened end of existing caps narrows the width of the caps so that they can be easily inserted into the windings, however it also creates a sharp edge. Due to hardening of the tube material that takes place as a consequence of heat-shrinking, this sharp edge is very hard, and so it can damage an assembler's fingers unless a protective garment is worn over the fingers.

There have been various attempts to mitigate this sharp edge, such as by trimming off the corners into a semi-circular shape, or by fully heat-shrinking just the end of the tube to narrow the end of the tube by enough to block the wires. However, the hard end of the tube still remains.

More recently, it has also been discovered that the hard ends of the tubes can sometimes scratch off the insulative coatings that are applied to motor winding wires, damaging the windings, and increasing the chances of short-circuits occurring between the windings.

It is therefore an aim of the invention to provide an electrically insulating cap which does less damage to motor windings, and to assembler's fingers.

### SUMMARY OF THE INVENTION

According to various embodiments of the invention, there is provided an electrically insulating cap according to any one of the appended claims. The cap comprises a tube having a tube radius, an opening at a first end of the tube for receiving electrical wires, and a joint between two opposing sides of the tube within an interior of the tube. The joint blocks the tube at a point along a length of the tube to prevent the electrical wires from entering beyond a fixed distance into the tube. The joint is spaced away from a second end of the tube by a standoff distance, the second end of the tube being opposite the first end of the tube. The standoff distance is greater than the radius of the tube and less than five times the radius of the tube. The tube is formed of an outer tube of a non heat shrinkable material around an inner tube of a heat shrinkable material.

Since the inner tube is inside of the outer tube, when the tube is heated to shrink it around the electrical connection and the inner tube hardens, this hardened inner tube is shielded from the assembler's fingers and the motor windings by the outer tube. Since the outer tube is made of a non heat shrinkable material, it remains soft even after the heat shrinking process, and so does not risk damage to the assembler's fingers or the motor windings.

Typically, the inner and outer tubes are concentric with one another. Preferably, the internal diameter of the outer tube matches the external diameter of the inner tube prior to the heat shrinking process, so that the outer and inner tubes are in direct contact with one another around the whole circumference of the tube, and together form a single tube. When the heat shrinking of the inner tube takes place, the inner tube at least partially separates from the outer tube as it shrinks, to grip the electrical connection and wire insulation. The joint keeps the inner and outer tubes in place with one another after the shrinking has taken place. The shrinking typically causes a reduction in the width of the inner tube, and preferably also a reduction in the length of the inner tube, helping shield the inner tube inside of the outer tube.

Furthermore, since the joint is spaced from the end of the tube by a standoff distance that is greater than the radius of the tube, leaving the opposing sides of the tube unjoined along the standoff distance, there is a sufficiently long distance between the joint and the end of the tube for the tube to recover enough flexibility to avoid the end damaging assembler's fingers or scratching through insulative coatings of motor windings. Clearly, the closer the joint is to the end of the tube, the more the joint will restrict flexing of the tube at the end of the tube. Additionally, the closer the joint is to the end of the tube, the more likely the end of the tube is to reach an elevated temperature whilst creating the joint, this elevated temperature causing hardening of the end of the tube.

Preferably, the standoff distance is less than four times the radius of the tube, as standoff distances greater than this may be wasteful of tube, and may allow the tube to almost fully recover its tubular shape at the second end, making it more difficult to insert the tube into the motor windings. More preferably, the standoff distance is less than three times the radius of the tube.

Preferably, the standoff distance is between one and three times the radius of the tube, more preferably approximately twice the radius of the tube.

The ideal standoff distance varies according to the radius of the tube, although for common tube sizes, the standoff distance may be between 3 mm and 7 mm, more preferably between 4 mm and 6 mm.

The joint may be formed by a joint region of the tube, and the joint region defined as a region over which the opposing sides of the tube are joined to one another. Preferably, the opposing sides of the tube are joined directly to one another, for example by sonic or heat welding techniques. Then, areas where the opposing sides contact one another are considered to be part of the joint region, and areas where the opposing sides do not contact one another are not considered to be part of the joint region.

The joint region may have a width extending in a direction across a width of the tube, and preferably the width of the joint region does not extend all the way across the width of the tube. Then, the tube at either end of the width of the joint portion will remain softer, and should not cause damage to either the motor windings or the assembler's fingers.

Preferably, the width of the joint region is no greater than the tube radius, more preferably no greater than two thirds of the tube radius, and even more preferably no greater than half the tube radius. Accordingly, the joint region may divide the interior of the tube into two separate channels that pass on opposite sides of the joint within the tube. The short width of the joint causes the joint region to be sunk into the middle of the tube, such that any external planar surfaces will abut against the tube surrounding the joint, and not against the joint itself. The joint region may extend over an area no greater than an area equal to the tube radius multiplied by the tube radius, to minimise the area of the tube that is hardened by the joint.

The tube radius is considered to be the distance from the central axis of the tube to the external surface of the tube, which will be the external surface of the outer tube. The thickness of the tube wall is typically insignificant in comparison to the tube radius, as the inner and outer tube walls are very thin. The heat shrinking of the inner tube does not have much effect on the radius of the outer tube, however for avoidance of any doubt the radius is measured when the tube is in its un-shrunk state. The radius of the tube is typically constant along the length of the tube, although if there are variations in radius along the length of the tube then the tube radius is considered to be the radius of the tube at the joint prior to forming the joint. References to “the tube” herein are references to the inner and outer tubes in combination

### DESCRIPTION OF THE FIGURES

Embodiments of the invention will now be described by way of non-limiting example only and with reference to the accompanying drawings, in which:

FIG. 1a shows plan view of a known electrically insulating cap;

FIG. 1b shows a cross-sectional view of the electrically insulating cap of FIG. 1a;

FIG. 1c shows an end view of the electrically insulating cap of FIG. 1a;

FIG. 2a shows a plan view of an electrically insulating cap according to an embodiment of the invention;

FIG. 2b shows a side view of the electrically insulating cap of FIG. 2a;

FIG. 2c shows an end view of the electrically insulating cap of FIG. 2a; and

FIG. 3 shows a cross-sectional view of the electrically insulating cap of FIG. 2a.

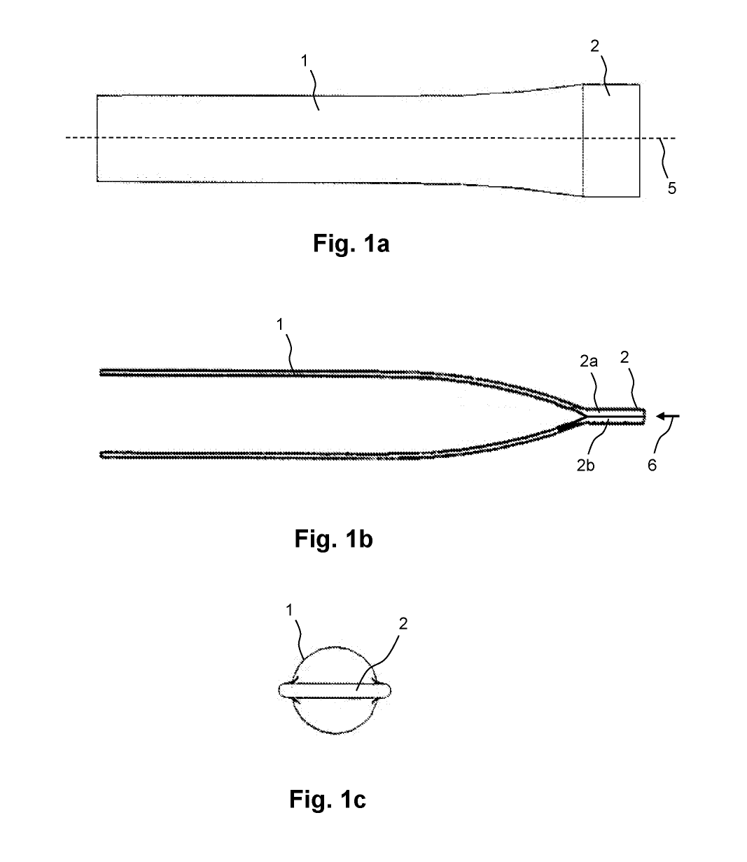

The figures are not to scale, and same or similar reference signs denote same or similar features.

### DETAILED DESCRIPTION

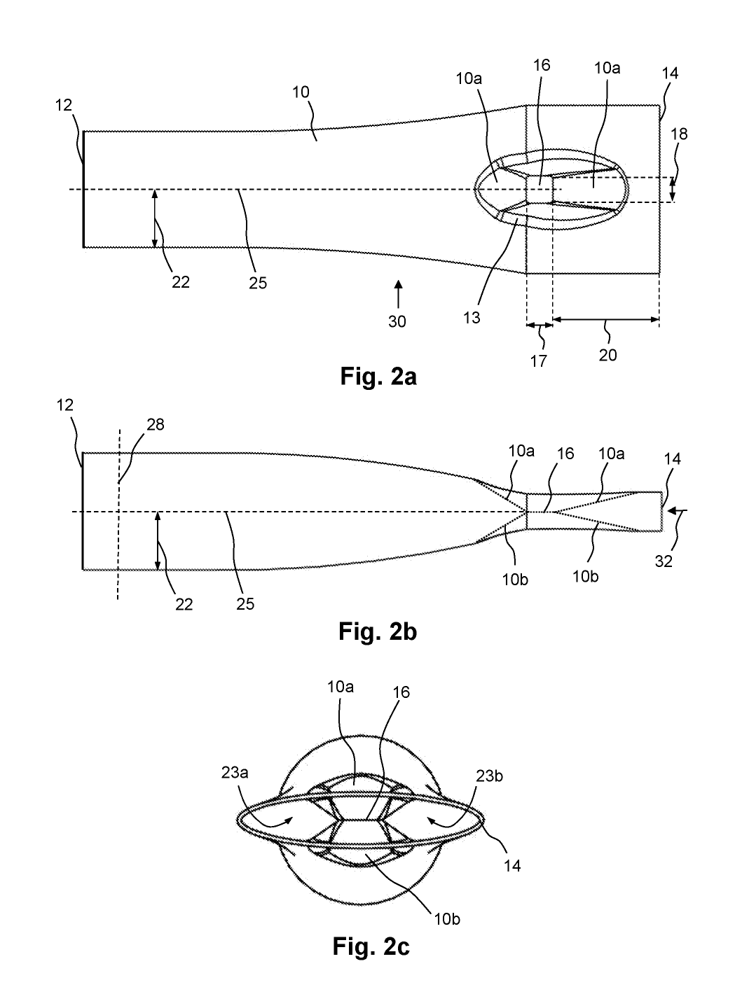

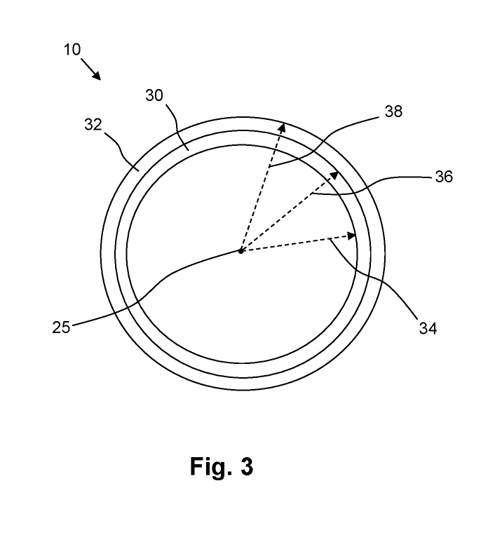

An embodiment of the invention will now be described with reference to FIGS. 2a to 3. FIG. 2a shows a plan view of an electrically insulating cap 8. FIG. 2b shows a side view of the cap 8, taken looking from a direction 30 marked on FIG. 2a. And, FIG. 2c shows an enlarged view of an end of the cap 8, taken looking from a direction 32 marked on FIG. 2b.

The electrically insulating cap 8 comprises a polymeric tube 10, having a length extending between a first end 12 and second end 14. The tube 10 has been wound from strips of material, using known techniques, and has an inner heat-shrinkable layer and an outer non heat-shrinkable layer. The tube 10 has been illustrated in its unshrunk state.

The tube 10 has a substantially circular cross section and extends between the first 12 and second 14 ends along a central axis 25. The tube has a constant diameter along the whole of its length, although appears wider towards the second end 14 in FIG. 2a and FIG. 2b, due to partial flattening of the tube near the second end 14.

This partial flattening of the tube is a result of opposing sides 10a and 10b of the tube having been joined together with one another inside of the tube, by sonically welding two opposing sides 10a and 10b of the tube together at a joint region 16. The opposing sides 10a and 10b of the tube are diametrically opposite from one another about the central axis 25. These sides 10a and 10b are marked in phantom in FIG. 2b, since they are obscured from view by the remainder of the tube 10.

As shown in FIG. 2a, the joint region 16 has a length extending a distance 17 along the central axis 25. The joint region 16 also has a width extending a distance 18 perpendicular to the central axis 25, partially across the width of the tube. The distances 17 and 18 are each less than the radius 22 of the tube, and in this embodiment are each approximately half the radius 22 of the tube.

The joint region 16 is spaced apart from the second end 14 of the tube by a standoff distance 20, which allows the tube to at least partially recover its circular cross section between the joint region 16 and second end 14.

The joint between the opposing sides 10a and 10b of the tube forms an oval shaped depression in the surface at each side of the tube, and the oval shaped depression in the top surface is generally outlined at 13 in FIG. 2a.

Since the joint region 16 extends a distance 18 that is less than the full width of the tube, the tube begins to recover its circular shape at widths beyond the joint region 18, and so is more flexible than it would otherwise have been. In particular, the tube partially recovers to the left and right sides of the joint region 16 as viewed in FIG. 2c, creating two passageways 23a and 23b through the tube at opposite sides of the joint region 16.

The tube 10 can be used to insulate a connection between electrical wires, by passing the connection into the first end 12 of the tube until it abuts against the joint region 16, and then heating the tube 10 to shrink the inner layer of the tube against the electrical wires to secure the tube in place.

A schematic cross-sectional view of the tube 10 is shown in FIG. 3. The cross-section has been taken along line 28 marked in FIG. 2b, and the relative thicknesses of the tube walls have been enlarged for clarity. As shown, the tube 10 comprises an inner heat-shrinkable tube 30 and an outer non heat-shrinkable tube 32, the inner tube 30 being concentrically inside the outer tube 32 and in direct contact with it so that the inner and outer tubes together form the single tube 10. The inner tube 30 has an internal radius 34, and an external radius 36. The external radius 36 of the inner tube 30 is the same as the internal radius of the outer tube 32. The external radius 38 of the outer tube 32 is considered to be the radius of the tube 10.

In this particular embodiment, the inner layer 30 is formed of heat shrinkable polyester, and the outer layer 32 is formed of non-shrink polyester. Alternative materials could be used instead of these, as will be apparent to those skilled in the art. For example, the outer layer 32 may be formed of non-shrink polyamide instead of non-shrink polyester, to withstand higher temperatures.

In this particular embodiment, the tube 10 has an outside diameter of 4.5 mm, giving a radius 38 of 2.25 mm. The total thickness of the inner and outer tube walls is 0.25 mm, giving an internal tube radius 34 of 2 mm. Referring back to FIG. 2a, the standoff distance 20 is 5 mm, and the distances 17 and 18 are each 1 mm. Clearly, these values can vary significantly in alternate embodiments.

Many other variations of the described embodiments falling within the scope of the invention will be apparent to those skilled in the art. For example, the size and positioning of the joint region 16 can easily be varied within the limits specified by the appended claims, and various different materials may be used to form the tube, which may or may not be heat shrinkable. For example, the tube may be formed of non-shrinkable polyamide films, or non-woven polyamide or polyester laminates.

The joint between the opposing sides of the tube could be formed using other types of welding, for example heat welding, or the opposing sides of the tube may be adhered to one other rather than welded. The tubes described herein have a circular cross-section, however this is not a requirement, and other tube cross sections such as rectangular cross sections could alternatively be used, the radius of such cross sections being the average distance between the central axis and the tube exterior.

What is claimed is:

1. An electrically insulating cap, the cap comprising a tube having a tube radius, an opening at a first end of the tube for receiving electrical wires, and a joint between two opposing sides of the tube within an interior of the tube, the joint blocking the tube at a point along a length of the tube to prevent the electrical wires from entering beyond a fixed distance into the tube, wherein the joint is spaced away from a second end of the tube by a standoff distance, the second end of the tube being opposite the first end of the tube, wherein the standoff distance is greater than the radius of the tube and less than five times the radius of the tube, and wherein the tube is formed of an outer tube of a non heat shrinkable material around an inner tube of a heat shrinkable material.

2. The electrically insulating cap of claim 1, wherein the standoff distance is greater than or equal to twice the radius of the tube.

3. The electrically insulating cap of claim 1, wherein the standoff distance is less than or equal to four times the radius of the tube.

4. The electrically insulating cap of claim 1, wherein the standoff distance is between 3 mm and 7 mm.

5. The electrically insulating cap of claim 1, wherein the joint divides the interior of the tube into two separate channels that pass on opposite sides of the joint within the tube.

6. The electrically insulating cap of claim 1, wherein the joint is formed by a joint region of the tube where opposing sides of the tube are joined to one another.

7. The electrically insulating cap of claim 6, wherein the opposing sides of the tube are joined in direct contact with one another.

8. The electrically insulating cap of claim 7, wherein the opposing sides of the tube are welded to one another.

9. The electrically insulating cap of claim 6, wherein the joint region extends over an area no greater than an area equal to the tube radius multiplied by the tube radius.

10. The electrically insulating cap of claim 6, wherein the joint region has a width extending in a direction across a width of the tube, and wherein the width of the joint region is no greater than the tube radius.
